(19) United States
(12) Patent Application Publication
(10) Pub. No.: US 2013/0100528 A1
(43) Pub. Date: Apr. 25, 2013

(54) PLANAR REFLECTIVE DEVICES

(71) Applicants: Marco Florentino, Mountain View, CA (US); David A. Fattal, Mountain View, CA (US); Raymond G. Beausoleil, Redmond, WA (US); Jingjing Li, Palo Alto, CA (US); Zhen Peng, Foster City, CA (US)

(72) Inventors: Marco Florentino, Mountain View, CA (US); David A. Fattal, Mountain View, CA (US); Raymond G. Beausoleil, Redmond, WA (US); Jingjing Li, Palo Alto, CA (US); Zhen Peng, Foster City, CA (US)

(21) Appl. No.: 13/280,831

(22) Filed: Oct. 25, 2011

(51) Int. Cl. G02B 5/18; G02B 5/30

(52) U.S. Cl. 359/485.01; 359/571

(57) ABSTRACT

Planar reflective devices that operate as reflective blazed diffraction gratings are disclosed. In one aspect, a reflective device includes a substrate with a planar surface, and a planar, high-contrast, sub-wavelength grating disposed on the surface. The grating is divided into a number of regions that each reflect incident light of a particular wavelength and with a particular angle of incidence into a single diffraction order and associated diffraction angle.

### BACKGROUND

Resonant effects in dielectric gratings were identified in the early 1990's as having promising applications to free-space optical filtering and sensing. Resonant effects typically occur in sub-wavelength gratings, where the first-order diffracted mode corresponds not to freely propagating light but to a guided wave trapped in some dielectric layer. When a high-index-contrast grating is used, the guided waves are rapidly scattered and do not propagate very far laterally. As a result, the resonant feature can be considerably broadband and of high angular tolerance, which has been used to design novel types of highly reflective mirrors. Recently, sub-wavelength grating mirrors have been used to replace the top dielectric stacks in vertical-cavity surface-emitting lasers, and in novel micro-electromechanical devices. In addition to being more compact and relatively cheaper to fabricate, sub-wavelength grating mirrors also provide polarization control.

Although in recent years there have been a number of advances in sub-wavelength gratings, designers, manufacturers, and users of optical systems continue to seek grating enhancements that broaden the possible range of grating applications.

### DESCRIPTION OF THE DRAWINGS

FIG. 1A shows a side view of an example unblazed diffraction grating illuminated by light.

FIG. 1B shows an example plot of irradiance associated with diffraction orders for an unblazed grating.

FIG. 1C shows an example unblazed grating illuminated by a broad spectrum beam.

FIG. 2A shows a side view of an example blazed diffraction grating illuminated by light.

FIG. 2B shows an example plot of irradiance associated with diffraction orders of a blazed grating.

FIG. 3 shows an isometric view of an example planar reflective device.

FIGS. 4A-4B shows an isometric view and a cross-sectional view of a blazed grating, respectively.

FIG. 5 shows a top-plan view of the reflective device shown in FIG. 3.

FIG. 6 shows a plot of reflectance and phase shift over a range of incident light wavelengths for an example one-dimensional sub-wavelength grating.

FIG. 7 shows a cross-sectional view of a reflective surface, a corresponding region of planar reflective and a phase profile.

FIGS. 8A-8D show side and magnified views of the reflective device shown in FIG. 3.

FIG. 9 shows a plot of transmittance and phase for a thin silicon sub-wavelength grating disposed on quartz substrate.

FIG. 10A shows a microscope top-plan view of a high-contrast sub-wavelength grating of a planar reflective device.

FIG. 10B shows a scanning electron microscope image of the sub-wavelength grating of the reflective device shown in FIG. 10A.

FIG. 11 shows a plot of reflected power versus scattering angle for the reflective device shown in FIG. 10A.

FIG. 12 shows a top-plan view of an example planar reflective device.

FIG. 13 shows a top-plan view of an example polarization insensitive planar reflective device.

### DETAILED DESCRIPTION

Planar reflective devices that operate as reflective blazed diffraction gratings are disclosed. The reflective devices include a high-contrast sub-wavelength grating (“SWG”) disposed a lower refractive index substrate. The SWG is configured with a periodic structure to direct much of the incident light of a particular wavelength into one diffraction order with a corresponding diffraction angle. In the following description, the term “light” refers to electromagnetic radiation with wavelengths in the visible and non-visible portions of the electromagnetic spectrum, including infrared and ultra-violet portions of the electromagnetic spectrum.

### Unblazed and Blazed Diffraction Gratings

In this subsection, a brief and general description of blazed and unblazed gratings is provided in order to appreciate how the planar reflective devices described in greater detail below operate in the same manner as blazed gratings. Readers already familiar with reflective unblazed and blazed diffraction gratings may skip this section.

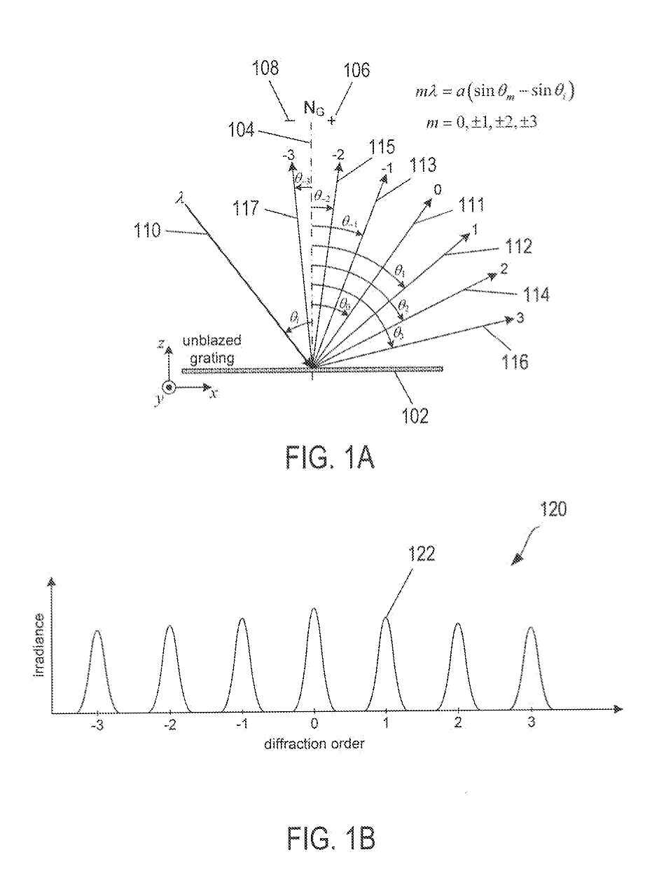

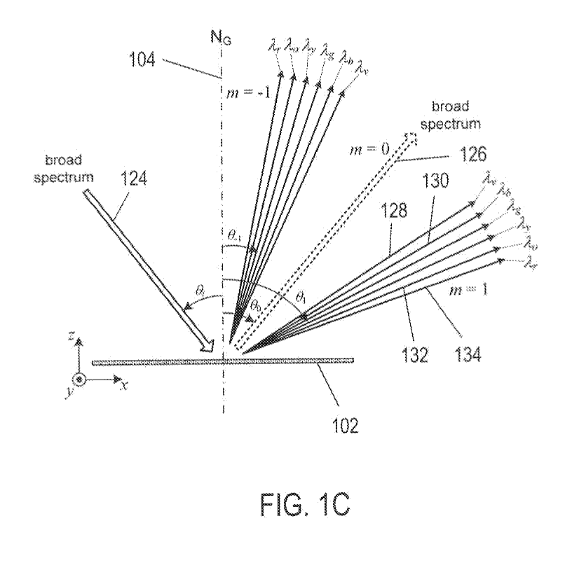

FIG. 1A shows a side view of an example unblazed diffraction grating 102 illuminated by light with a wavelength λ. Dot-dash line 104 is directed perpendicular to the xy-plane of the grating 102 and represents the grating normal denoted by N_{G}. Plus sign 106 and minus sign 108 represent a sign convention associated with the angles at which light is incident on, and is diffracted from, the grating 102 with respect to the grating normal N_{G} 104. The grating 102 is composed of a set of long and narrow slits of spacing a (not shown). When light with the wavelength λ is incident with an angle of incidence θᵢ with respect to the grating normal N_{G}, each slit in the grating acts as a point source to reflect light in all directions. In general, when the path difference between the light reflected from adjacent slits is equal to the wavelength λ the waves are in phase and the light constructively interferes to produce beams of light, with each emanating from the grating at an angle θₘ with respect to the grating normal, where m is an integer 0, ±1, ±2, ±3, . . . referred to as the “diffraction order” or simple “order.” On the other hand, when the phases of the waves reflected from different slits vary so that certain reflected waves partially or wholly destructively interfere dark regions are created between the beams. In other words, light is diffracted from the grating 102 in beams with irradiance maxima occurring at the angles θₘ separated by dark regions. The grating equation mathematically characterizes the angle at which the principle maxima occur with respect to the grating normal and is given by:

mλ=a(sin θₘ+sin θᵢ)

In FIG. 1A, directional arrow 110 represents a ray of the incident light with an angle of incidence −θᵢ. Directional arrows 111-117 emanating from the grating 102 represent the directions of seven separate diffracted beams of light that correspond to the diffraction orders 0, ±1, ±2, ±3. Each of the diffracted beams 111-117 is separated by a dark region created by destructive interference. Central beam 111 corresponds to specular reflection and has the zeroth diffraction order denoted m=0. The other beams 112-117 occur at angles which are represented by non-zero diffraction orders m. FIG. 1B shows an example plot 120 of irradiance associated with each of the diffraction orders. For example, peak 122 represents the irradiance distribution of the first-order beam 112. Each peak in the plot 120 represents how the irradiance of the incident light is distributed among the diffracted beams with the largest portion, in this example, going into the zeroth-order beam 11.

When a grating is illuminated with light over a broad spectrum of wavelengths, such as “white” light, the light is separated into its component wavelengths in much the same way light is separated into component wavelengths by a prism. FIG. 1C shows the grating 102 illuminated by a broad spectrum beam represented by a directional arrow 124 with an angle of incidence −θᵢ. The beam is composed of violet, blue, green, yellow, orange and red component wavelengths denoted by λᵥ, λ_{b}, λ_{g}, λ_{y}, λₒ and λᵣ, respectively. For the sake of brevity, FIG. 1C shows only the zeroth, first, and minus first orders. Directional arrow 126 represents the portion of incident light diffracted into the zeroth-order beam, which is not spread into separate component wavelengths by the grating 102. The portion of incident light diffracted into the first and minus first orders is separated according to the component wavelengths. Based on the diffraction equation the diffraction angles are given by:

$${θ}_{m} ( λ ) = {sin}^{- 1} ( \frac{m λ}{a} - sin {θ}_{i} )$$

where, as shown in FIG. 1C, θ₁(λᵣ)>θ₁(λₒ)>θ₁(λ_{y})>θ₁(λ_{g})>θ₁(λ_{b})>θ₁(λᵥ) and θ₋₁(λᵥ)>θ₋₁(λ_{b})>θ₋₁(λ_{g})>θ₋₁(λ_{y})>θ₋₁(λₒ)>θ₋₁(λᵣ). For example, directional arrows 128 and 130 represent first-order violet and blue components which have smaller diffraction angles than do the first-order orange and red components represented by directional arrows 132 and 134.

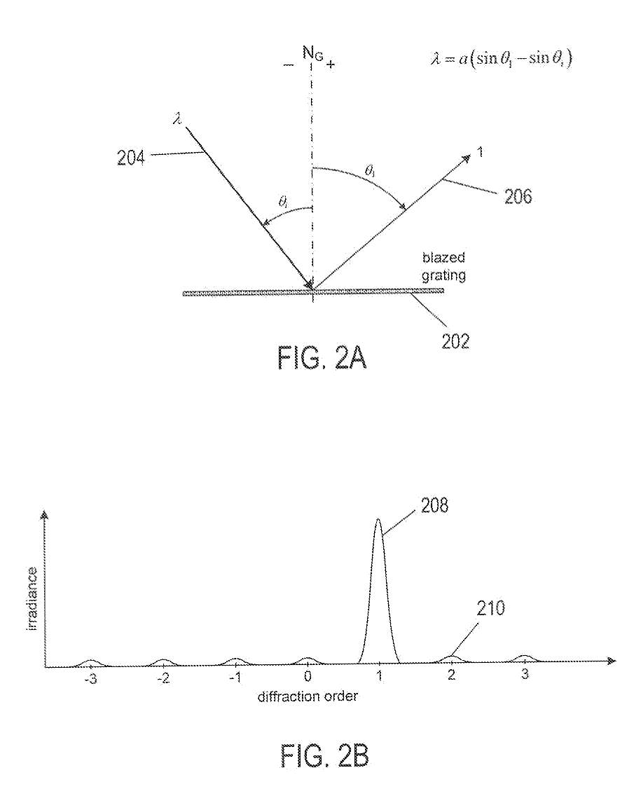

Unlike the unblazed grating 102, a blazed grating concentrates most of the diffracted light into one diffraction order and significantly reduces the amount of light diffracted into the other diffraction orders. FIG. 2A shows a side view of an example blazed diffraction grating 202 illuminated by light with the wavelength λ. Directional arrow 204 represents a ray of an incident beam of light with the wavelength λ and angle of incidence −θᵢ. In this example, light from the incident beam is primarily diffracted into a first-order beam represented by directional arrow 206 with a first-order angle θ₁.

The first-order angle is determined by the angle of incidence θᵢ and the wavelength λ and is characterized by the grating equation θ₁=sin⁻¹(λ/a−sin θᵢ). In other words, changes in the angle of incidence and/or the wavelength of the incident beam results in changes in the diffraction angle. FIG. 2B shows an example plot of irradiance associated with each of the diffraction orders of the blazed grating 202. Peak 208 represents the irradiance associated with the first-order beam 206 shown in FIG. 2A, and smaller peaks, such as smaller peak 210, represent the irradiance associated with the other diffraction orders.

### Sub-Wavelength Gratings

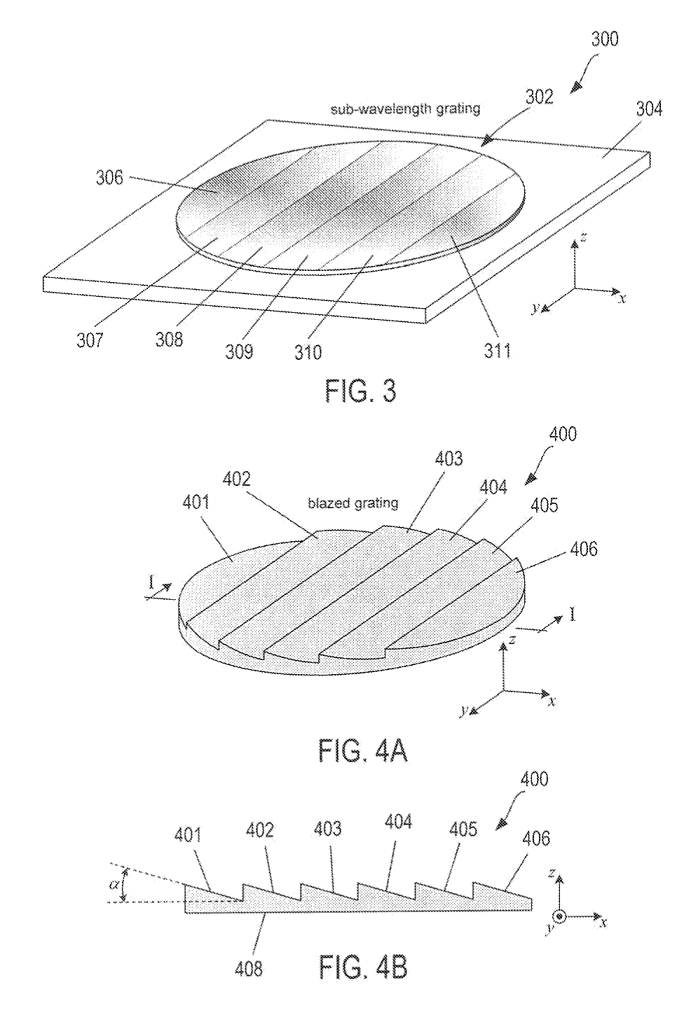

FIG. 3 shows an isometric view of an example reflective device 300 configured to operate in the same manner as a blazed diffraction grating. The diffraction grating 300 includes a disk-shaped SWG 302 disposed on a planar surface of a substrate 304. The example SWG 302 is divided into six regions 306-311 that each diffract incident light of a particular wavelength in the same manner. The diffraction grating 300, as described in greater detail below, is configured to function in the same manner as an example blazed diffraction grating 400 shown in FIGS. 4A-4B. FIG. 4A shows an isometric view of the blazed grating 400, and FIG. 4B shows a cross-sectional view of the blazed grating 400 along a line I-I shown in FIG. 4A. The blazed grating 400 is composed of a series of six angled reflective surfaces 401-406 that each reflect incident light. Each reflective surface of the grating 400 can be formed using mechanical ruling or complex lithography. As shown in FIG. 4B, each reflective surface is angled with the same blaze angle, α, with respect to a planar surface 408. In general, blazed gratings suffer from detrimental shadowing effects caused by the raised portions of each angled surface blocking the path of reflected light, which ultimately limits the blazed grating efficiency. On the other hand, the example diffraction grating 300 reflects light with high efficiency into a particular diffraction order and does not suffer from angled surface blocking. As shown in the example of FIG. 3, the regions 306-311 are planar and each region of the SWG 102 diffracts incident light in the same manner as the angled reflective surfaces 401-406, respectively, but without angled surface blocking.

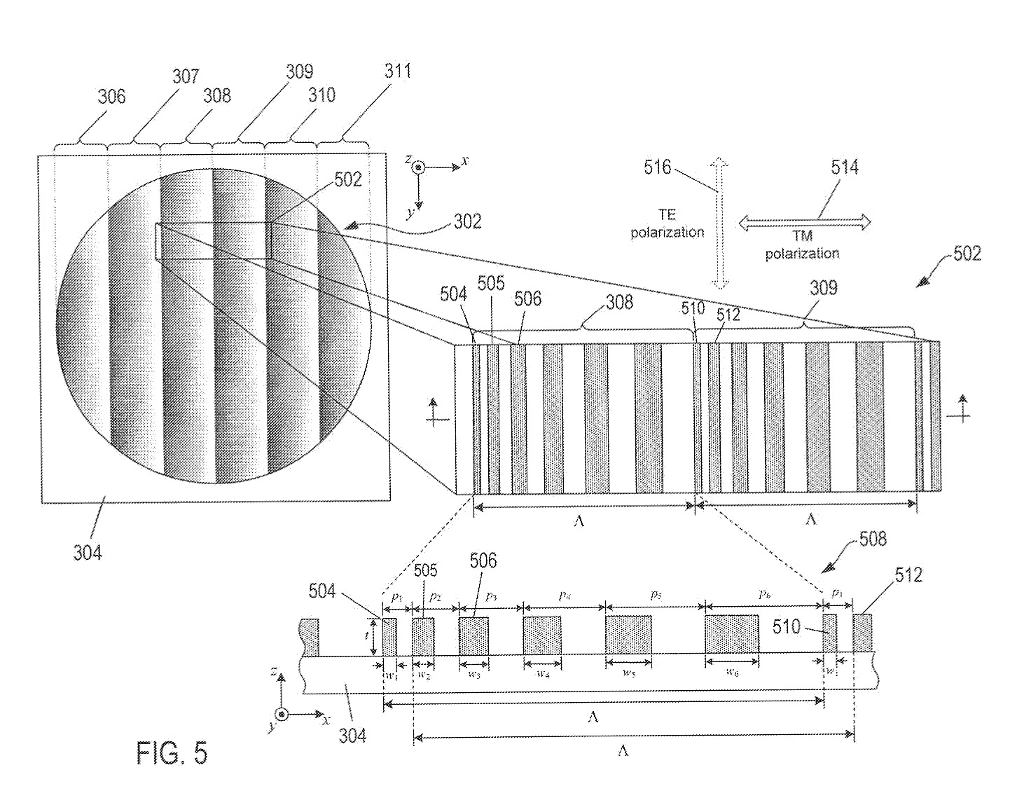

FIG. 5 shows a top-plan view of the diffraction grating 300. The regions 306-311 are shaded to represent how the grating varies within each region in the x-direction. Each of the regions 306-311 is designed to operate like a reflective surface of a blazed grating for a selected wavelength of light but without surface blocking. In the example of FIG. 5, the SWG 302 is a one-dimensional grating composed of approximately parallel wire-like protrusions called “lines” separated by grooves. FIG. 5 includes a magnified top-plan view 502 of portions of regions 308 and 309, which reveals that the SWG 302 is a one-dimensional grating. The magnified view 502 shows lines, such as lines 504-506 of the region 108, that extend in the y-direction and are spaced in the x-direction. FIG. 5 also includes a further magnified cross-sectional view 508 of the region 308. The parameters wᵢ and pᵢ represent the line width and line spacing, respectively, where i is an integer ranging from 1 to 6. The lines comprising the SWG 302 have approximately the same thickness t throughout. As shown in the example of FIG. 5, each region of the SWG 302 is composed of six lines that increase in width and spacing in the x-direction. For example, the line widths and spacing of the lines 504-506 satisfy the conditions w₁<w_{z}<w₂ and p₁<p_{z}<p₂. The pattern of line width and line spacing is repeated for each region with a grating period denoted by Λ. For example, the regions 308 and 309 have approximately the same width Λ, and the spacing between the line 304 of the region 308 and a corresponding line 510 of the region 309 is Λ. The cross-sectional dimensions of the lines and the line spacing associated with the region 308 is the approximately the same for the lines of the region 309. For example, the cross-sectional dimensions of the line 510 are the same as those of the line 504 (i.e., ˜t×w₁) and the line spacing between the line 510 and adjacent line 512 is also p₁.

The SWG 302 can be composed of a single elemental semiconductor, such as silicon (“Si”) and germanium (“Ge”), or a compound semiconductor, such as a III-V compound semiconductor, where Roman numerals III and V represent elements in the IIIa and Va columns of the Periodic Table of the Elements. III-V compound semiconductors can be composed of column IIIa elements, such as aluminum (“Al”), gallium (“Ga”), and indium (“In”), in combination with column Va elements, such as nitrogen (“N”), phosphorus (“P”), arsenic (“As”), and antimony (“Sb”). III-V compound semiconductors can also be further classified according to the relative quantities of III and V elements. For example, binary semiconductor compounds include semiconductors with empirical formulas GaAs, InP, InAs, and GaP; ternary compound semiconductors include semiconductors with empirical formula GaAs_{y}P_{1-y}, where y ranges from greater than 0 to less than 1; and quaternary compound semiconductors include semiconductors with empirical formula InₓGa₁₋ₓAs_{y}P_{1-y}, where both x and y independently range from greater than 0 to less than 1. Other types of suitable compound semiconductors include II-VI materials, where II and VI represent elements in the IIb and VIa columns of the periodic table. For example, CdSe, ZnSe, ZnS, and ZnO are empirical formulas of exemplary binary II-VI compound semiconductors. The substrate 304 can be composed of material having a relatively lower refractive index than the SWG 302. For example, the substrate 304 can be composed of quartz, silicon dioxide (“SiO₂”), aluminum oxide (“Al₃O₂”), or a polymer.

Fabrication of the diffraction grating 300 begins with a layer of high refractive index material, such as Si, deposited on a planar surface of a lower refractive index substrate, such as quartz. The high refractive index material is thinned to a desired, substantially uniform, thickness t using thermal oxidation. For example, the high refractive index material may initially have a thickness of approximately 250 nm and be thinned using thermal oxidation to a thickness of approximately 170 nm or approximately 180 nm. The oxide is removed using a buffered oxide etchant and a polymethyl methacrylate (“PMMA”) resist can be applied to the high refractive index material followed by use of electron beam lithography to form the grating pattern in the PMMA. The developed PMMA pattern undergoes a weak oxygen descum to remove resist residues. Finally, the SWG features are etched in HBr plasma using an oxide reactive ion etcher.

As shown in the cross-sectional view 508 of FIG. 5, the grooves between lines are essentially free of the line material, exposing the surface of the substrate 304 between each line. In other words, the lines are formed so that portions of the substrate 304 are exposed between the lines. As a result, the SWG 302 is referred to as a “high-contrast” SWG because of the relatively high contrast between the refractive index of the material comprising the SWG 302 and the lower refractive index of the substrate 304. For example, elemental semiconductors Si and Ge, and many III-V compound semiconductors, that can be used to form the SWG 302 have effective refractive indices greater than approximately 3.5 when interacting with light of a wavelength 632.8 nm. By contrast, quartz, SiO₂, and polyacrylate, which can be used to form the substrate 304, each have an effective refractive index less than approximately 1.55 when interacting with light of the same wavelength.

The light reflected from the SWG 302 is TM polarized because of the high-contrast between the refractive indices of the SWG and the substrate and because of the selected thickness t. TM polarization is represented in FIG. 5 by a double-headed directional arrow 514 oriented perpendicular to the lines of the SWG 302. With TM polarization, the electric field component of light reflected from the SWG 302 is directed perpendicular to the lines of the SWG 302. By contrast, TE polarization is also represented in FIG. 5 by a dashed-line, double-headed directional arrow 516 oriented parallel to the lines of the SWG 302. With TE polarization, the electric field component of light that would be reflected from the SWG 302 is directed parallel to the lines of the SWG 302. However, the line thickness t and high-contrast aspect of the SWG 302 ensures are selected to ensure that the light reflected from the grating 304 is primarily composed of TM polarized light.

The SWG 302 is called a sub-wavelength grating because the cross-sectional dimensions of the lines and the line spacing are smaller than the wavelengths of the light the SWG 302 is intended to interact with. For example, the line widths can range from approximately 10 nm to approximately 300 nm and the line spacing can range from approximately 20 nm to approximately 1 μm or more depending on the wavelength of the incident light. The wavelength of light reflected from the regions 306-311 is determined by the line thickness t and the duty cycle defined as:

$$DC = \frac{w}{p}$$

In general, the contrast between the refractive indices of the lines of an SWG and air, changes the behavior of light as the light that moves between the SWG and the air surrounding the SWG. The reflection coefficient that characterizes the behavior of light that moves between an SWG and air is given by:

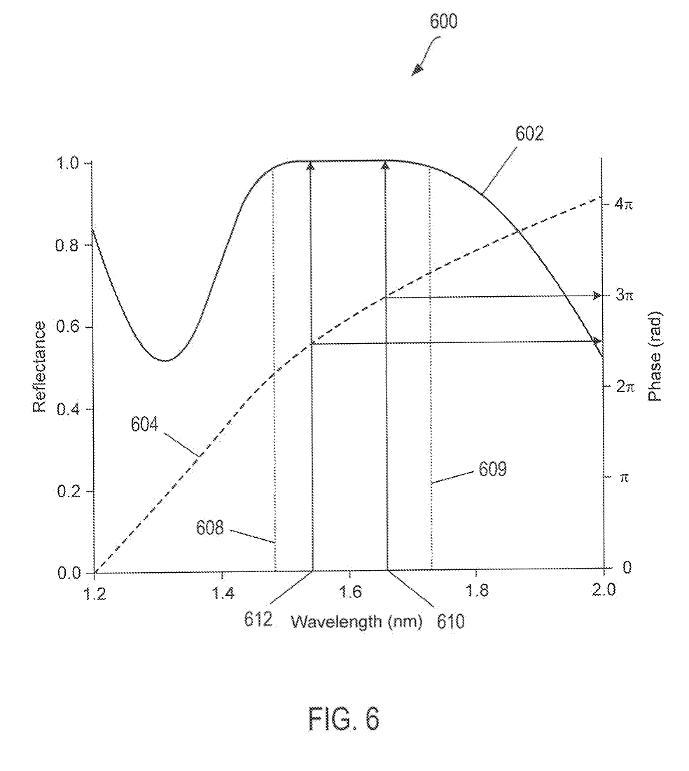

r(λ)=\sqrt{R(λ)}e^{iφ(λ)}

where R(λ) is the reflectance of the SWG, and φ(λ) is the phase shift in the light reflected off of the SWG. FIG. 6 shows a plot of reflectance and phase shift over a range of incident light wavelengths for an example one-dimensional SWG. Solid curve 602 corresponds to the reflectance R(λ), and dashed curve 604 corresponds to the phase shift φ(λ) produced by the SWG for incident light in the wavelength range of approximately 1.2 μm to approximately 2.0 μm. The SWG whose reflectance and phase shift are represented in FIG. 6 reflects TM polarized light over the wavelength range. The reflectance 602 and phase 604 curves were determined using MEEP, a finite-difference time-domain (“FDTD”) simulation software package used to model electromagnetic systems (see http://ab-initio.mit/edu/meep/meep-1.1.1.tar.gz). Due to the strong refractive index contrast between the SWG and air, the SWG has a broad spectral region of high reflectivity 606 between dashed-lines 608 and 609. However, curve 604 reveals that the phase of the reflected light varies across the entire high-reflectivity spectral region 606.

When the spatial dimensions of the period, line thickness, and line width is changed uniformly by a factor η, the reflection coefficient profile remains substantially unchanged, but the wavelength axis is scaled by the factor η. In other words, when a grating has been designed with a particular reflection coefficient R₀ at a free space wavelength λ₀, a different grating with the same reflection coefficient at a different free space wavelength λ can be designed by multiplying the grating parameters, such as line spacing, line thickness, and line width, by the factor (=λ/λᵢ0, which gives λ/=r₀(λ₀). In particular, the grating parameters of a first SWG that reflects light of wavelength λ₀ with a high reflectivity can be used to create a second SWG that also reflects light with nearly the same high reflectivity but for a different wavelength λ based on the scale factor (=λ/λ₁0. For example, consider a first one-dimensional SWG that reflects light with a wavelength λₒ≈1.62 μm 610 and has a line thickness, line width, and line spacing represented by t, w, and p, respectively. Curves 602 and 604 reveal that the first SWG has a reflectance of approximately 1 and introduces a phase shift of approximately 3π rad in the reflected light. Now suppose a second one-dimensional SWG is desired with a reflectivity of approximately 1 but for the wavelength λ≈1.54 μm 612. The second SWG has a high reflectivity of approximately 1 with a line thickness, line width, and period ηt, ηw, and ηp, respectively, where (=λ/(λ₁0≈0.945). According to curve 604, the second SWG introduces a smaller phase shift of approximately 2.5π rad in the light reflected.

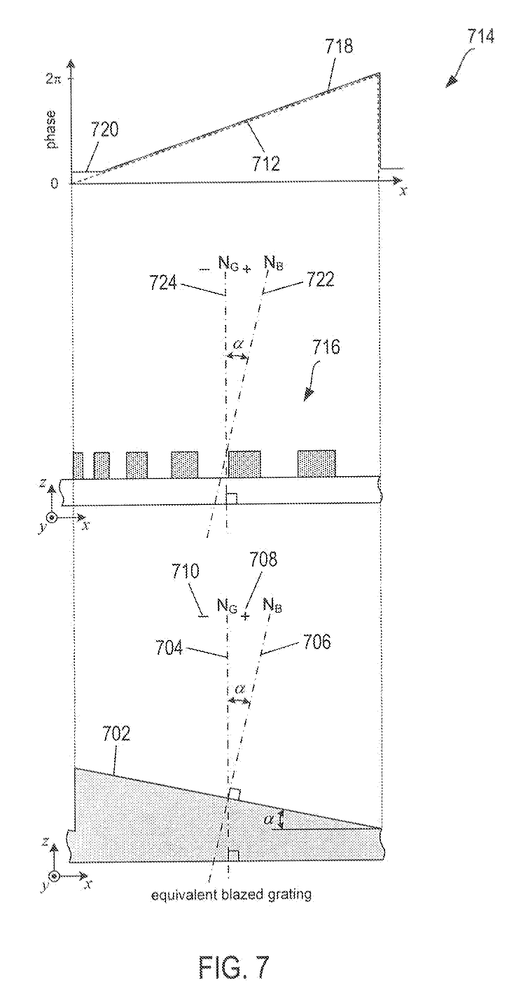

In order to understand how to obtain an effective blazed grating effect with the diffraction grating 300, consider initially a cross-sectional view in the xz-plane of a flat reflective surface 702 of a blazed grating tilted by a blaze angle α about the y-axis shown in FIG. 7. For example, the reflective surface 702 can represent any one of the reflective surfaces 401-406 of the blazed grating 400. Dot-dashed line 704 represents the grating normal N_{G} and dot-dashed line 706 represents the reflective surface normal N_{B}. Plus sign 708 and minus sign 710 represent a sign convention used throughout to describe angles at which light is incident on and is reflected from a reflective surface or grating region with respect to a grating normal N_{G}. The phase profile associated with the reflective surface 702 is given by

$${φ}_{mirror} ( x , y , λ ) = \frac{2 π sin 2 a}{λ} x$$

and is represented in FIG. 7 by a dashed line 712 in the xz-plane phase profile plot 714 with a slop 2π sin 2α/λ, where λ is the wavelength of the light incident on the reflective surface 702. Because λ∇φ is constant for all wavelengths in the visible spectrum, all wavelengths in the visible spectrum are identically reflected. Now consider a cross-sectional view of a region 716 that represents a cross-sectional view of any one of the regions 306-311 of the diffraction grating 300. The region 716 is configured in the same manner as the regions 308 and 309 described above. The line width, spacing, and thickness parameters associated with the lines comprising the region 716 are selected to produce a similar linear phase profile for a wavelength λ₀:

$${φ}_{0} ( x , y ) = \frac{2 π sin 2 a}{{λ}_{0}} x$$

This phase profile represents nearly the same amount of deviation in the phase as the reflective surface 702 but for the wavelength λ₀. For example, line 718 in the phase profile plot 714 represents the phase profile associated with the region 716. Flat segment 720 is the result of the finite line width and spacing limitations at which the lines and grooves can be fabricated and contributes to diffraction in the zero diffraction order, as explained in greater detail below in the Experimental Results section. The cross-sectional view of the region 716 is a hypothetical representation of how the line widths, spacings and thickness can be selected to produce the phase profile 718 and 720 for the wavelength λ₀. As shown in the example of FIG. 7, the region 716 has an associated reflective surface normal N_{B} 722 that represents how the region 716 is designed to reflect light with the wavelength λ₀ as if the region 716 were a reflective surface with a tilt angle α with respect to the diffraction grating normal 724. Based on the phase profile φₒ, a SWG, such as the example SWG 302, with a grating period Λ and blaze angle α can be designed by defining the overall phase profile of the diffraction grating as

$${φ}_{S} ( x , y , {λ}_{0} ) = \frac{2 π sin 2 a}{{λ}_{0}} ( x mod Λ )$$

For a flat reflection profile, the complex reflection coefficient of a diffraction grating configured to operate as a blazed grating is given by r_{B}=exp(iφ_{B}). In general, r_{B} is composed of a number of Fourier coefficients that characterize scattering in several diffraction orders. However, for particular values of θₘ/2 of the blaze angle given by sin(θₘ)=mλₒ/Λ, only the mth Fourier coefficient is present and nearly 100% of the scattering occurs in the diffraction order m.

### Operation of Planar Reflective Devices

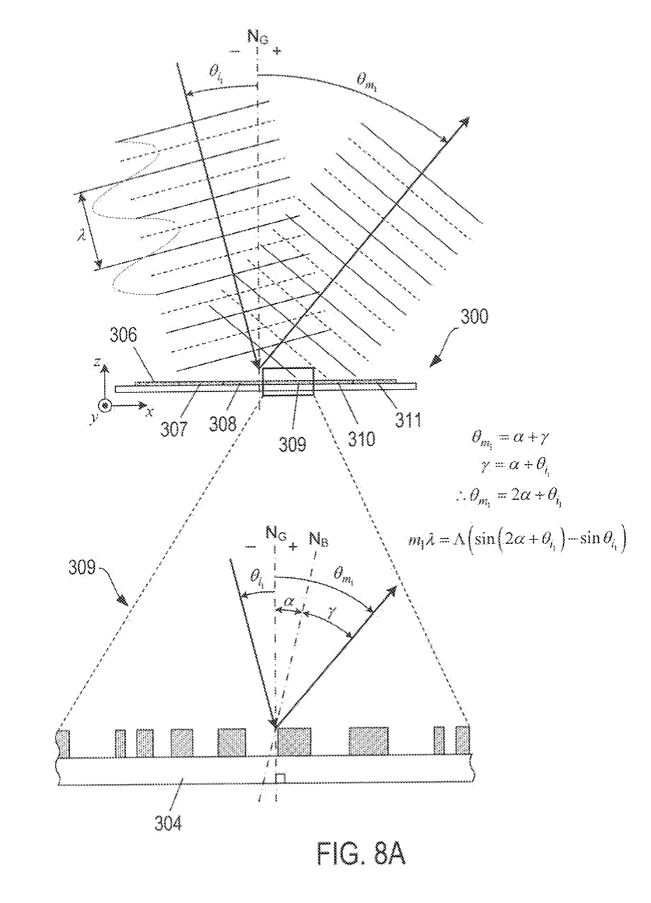

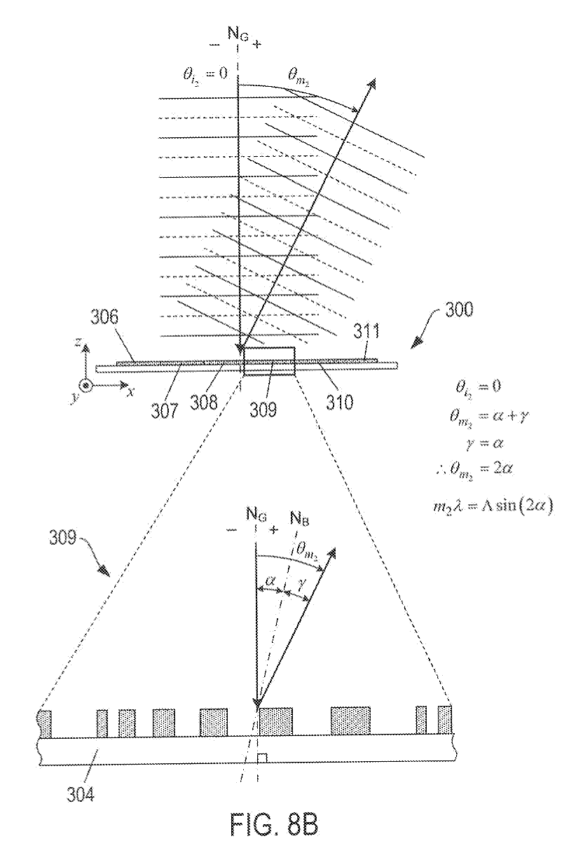

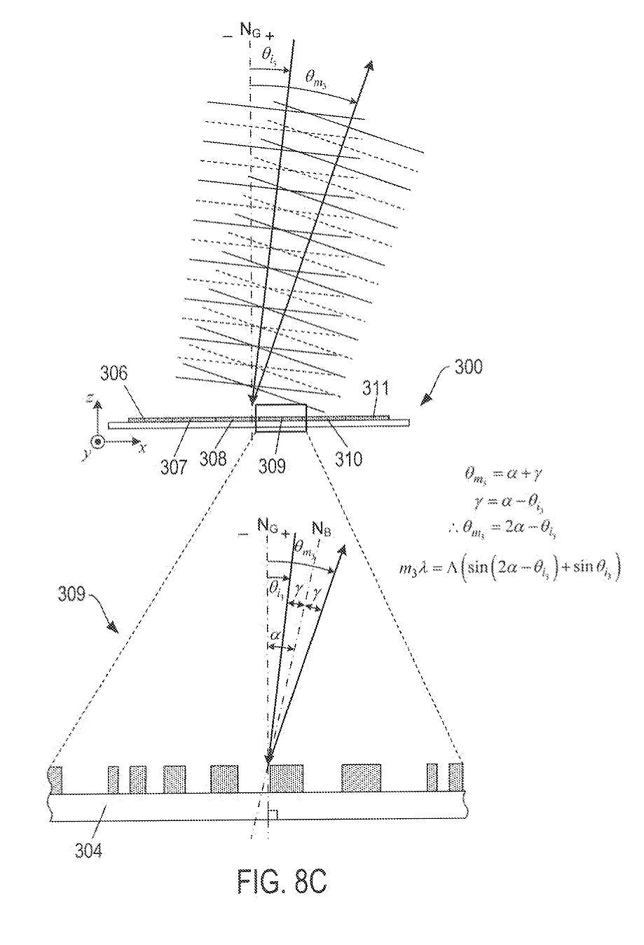

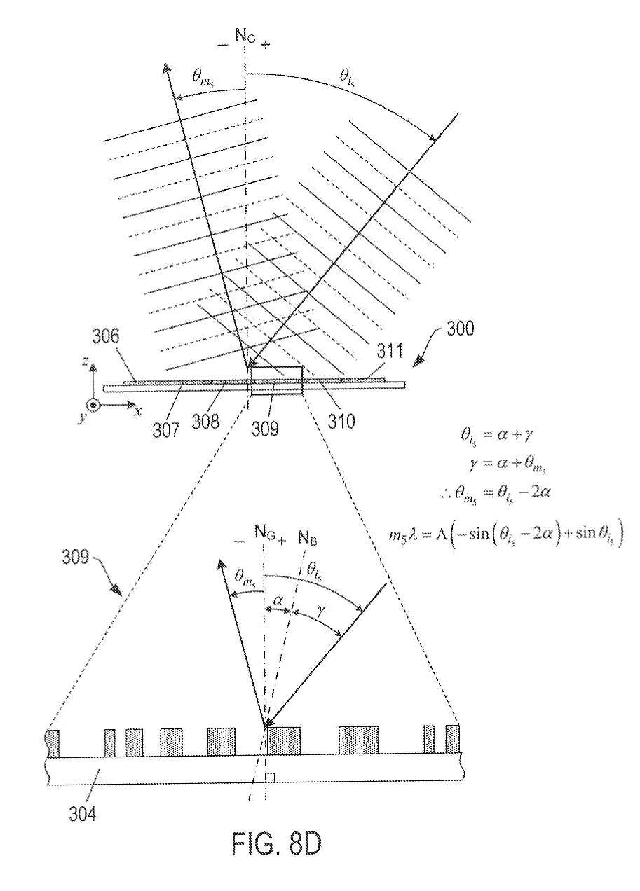

FIGS. 8A-8D show side and magnified views of the reflective device 300 operated to reflect light with a wavelength λ with different diffraction orders based on different angles of incidence. The following discussion is intended to demonstrate conceptually how the example diffraction grating 300 can be operated in same manner as a blazed grating with a blaze angle α, such as the example blazed grating 400. In other words, for each angle of incidence, the light is diffracted primarily into one diffraction order with a corresponding diffraction angle. FIGS. 8A-8D include a grating normal N_{G} and a magnified of side view of one region 309. FIGS. 8A-8D also include a blazed normal N_{B} associated with each region of the SWG 302 that represents how each region of the SWG 302 reflects light in nearly the same manner as the reflective surfaces 401-406 of the blazed grating 400, which are titled by the blaze angle α with respect to the grating normal N_{G}. In FIG. 8A, light is incident on the diffraction grating 300 with an angle of incidence −θᵢ_{₁} with respect to the grating normal N_{G}. The light is diffracted from the diffraction grating 300 into a single diffraction order m₁ with a diffraction angle θₘ_{₁}=2α+θᵢ_{₁}. In FIG. 8B, the light is incident on the diffraction grating 300 along the grating normal N_{G} (i.e., θᵢ_{₂}=0). The light in this case is diffracted from the diffraction grating 300 with a diffraction order m₂ and a diffraction angle θₘ_{₂}=2α. In FIG. 8C, the light is incident on the diffraction grating 300 with an angle of incidence between the grating normal and the blaze angle (i.e., 0<θᵢ_{₃}<α). The light in this case is diffracted from the diffraction grating 300 with a diffraction order m₃ and diffraction angle θₘ_{₃}=2α−θᵢ_{₃}. Note that as the angle of incidence approaches the blaze angle α (i.e., θᵢ_{₄}=α), the diffraction angle also approaches the blaze angle α(i.e., θₘ_{₄}=α) and the associated diffraction equation becomes m₄λ=2Λ sin θᵢ_{₄} with diffraction order m₄. In FIG. 8D, the light is incident on the diffraction grating 300 with an angle of incidence θᵢ_{₅} (i.e., θᵢ_{₅}>α). The light in this case is diffracted from the diffraction grating 300 with a diffraction order m₅ and diffraction angle θₘ_{₅}=θᵢ_{₅}−2α.

### Experimental Results

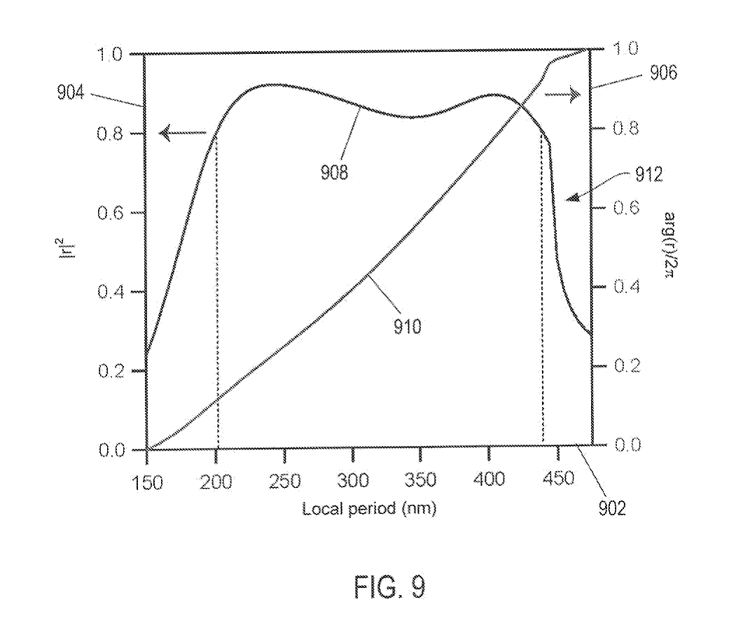

As explained above, a standard blazed grating uses a three-dimensional angled reflective surfaces (i.e., angled reflective surfaces) to achieve a particular phase profile. A standard blazed grating can be time consuming to fabricate and suffer from shadowing effects which limits efficiency. Instead, SWG parameters of a planar reflective device can be spatially modulated in order to build a reflective device with a phase profile that substantially matches that of a blazed grating for a particular diffraction order. In the following discussion, an SWG was designed was designed and fabricated for incident light with a wavelength of 650 nm. The SWG parameters were selected based on theoretical calculations with an SWG thickness of 170 nm. FIG. 9 shows a plot of theoretical transmittance and phase for a 170 nm thick Si SWG disposed on quartz substrate over a range of line spacings. The theoretical results were obtained for an SWG composed of Si lines with a refractive index of n=3.48 disposed on a quartz substrate with a refractive index of n=1.46. For the simulation, the SWG had a duty cycle of 50%. Horizontal axis 902 represents the line spacing in nanometers, and vertical axes 904 and 906 represent the reflectance |r|² and normalized argument or phase φ/2π, respectively, of the reflection coefficient r. Curves 908 and 910 representing the reflectance and normalized phase of the high-contrast Si on quartz diffraction grating were calculated using the rigorous couple-wave analysis (“RCWA”) method described in J. Opt. Soc. Am. A, by L. Li, No. 14, 2758 (1997). Below 450 nm the zeroth order is the only allowed order for the SWG. The onset of the first diffraction order at 450 nm shows as a drop 912 of reflectivity. The simulation results demonstrate that if Si of approximately 170 nm is selected for the SWG, reflectance in excess of 80% can be obtained for TM polarized light at 650 nm. FIG. 9 also shows that by changing the grating period, the phase of the reflected beam can span an interval of 2π with a small loss in reflectivity. Higher reflectivity designs can be found but with smaller feature size.

Experimental demonstration includes fabrication of the reflective device designed to operate with TM polarized light at approximately 650 nm wavelength with a first order diffraction angle θ₁=10°. For crystalline Si, it was found experimentally and theoretically that the optimum grating thickness t is in the range of about 160-180 nm, which is thin enough to greatly reduce the effects of Si absorption. To obtain a full 2π rad phase range, the grooves between lines were fabricated at less than 100 nm wide.

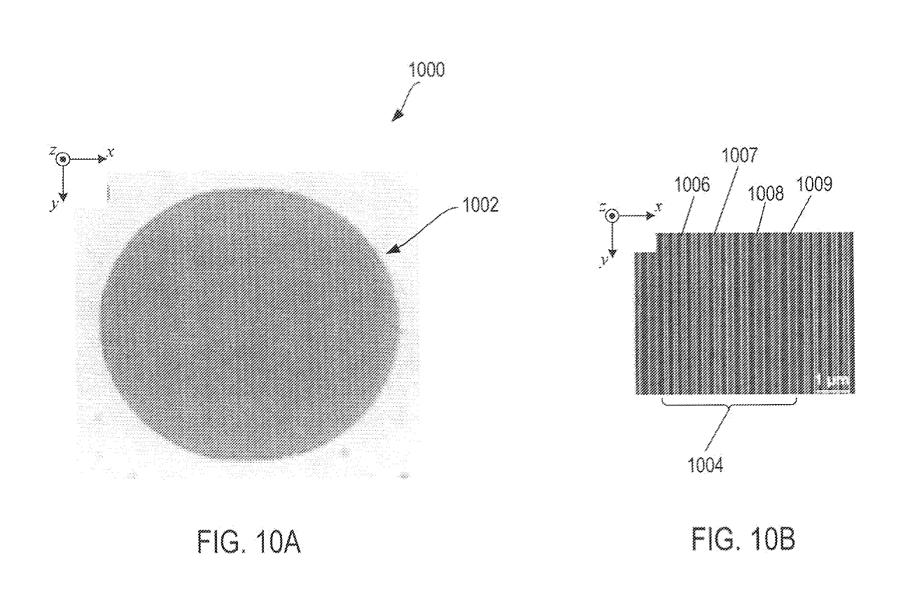

FIG. 10A shows a microscope top-plan view of the 150 μm diameter the actual high-contrast SWG 1002 of a reflective device 1000. The reflective device 1000 was fabricated as described above with reference to FIG. 3. FIG. 10B shows a scanning electron microscope image of a region 1004 of the SWG 1002 with line spacing varying from approximately 200 nm to approximately 500 nm in the x-direction at approximately 50% duty cycle. As shown in FIG. 10B, the lines, such as lines 1006-1009, comprising the region 1004 increase in width and spacing in the x-direction.

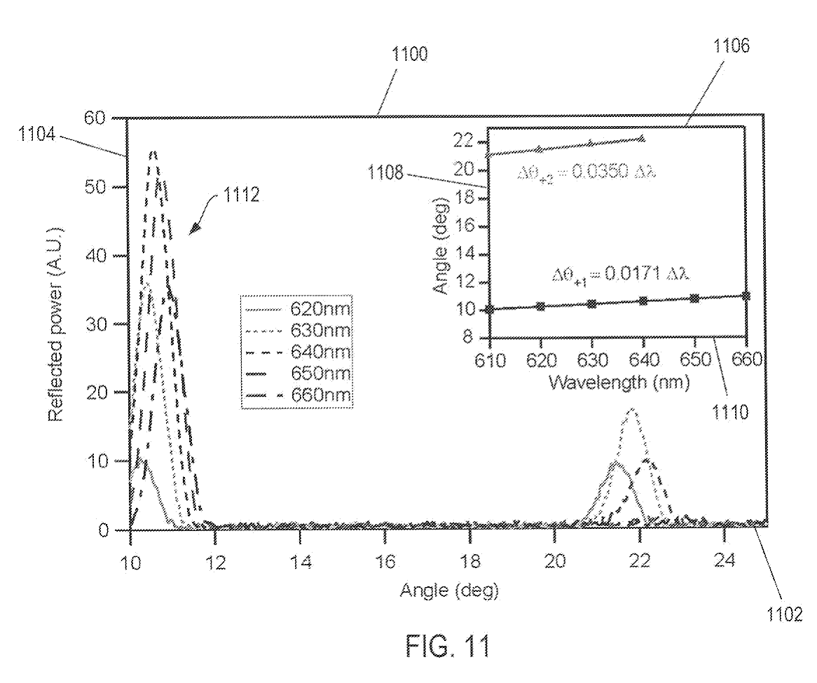

FIG. 11 shows a plot 1100 of reflected power versus scattering angle for the high-contrast reflective device 1000 at an angle of incidence of 10° for various test wavelengths. Horizontal axis 1102 represents the reflection angle and vertical axis 1104 represents the reflected optical power. FIG. 11 also includes an inset plot 1106 of the reflection angle, represented by vertical axis 1108, versus a range of test wavelengths, represented by horizontal axis 1110. The results presented in FIG. 11 were obtained using a broadband ellipsometer with a tunable light source. The ellipsometer was used to measure the scattering properties of the diffraction grating 1000 as various incident wavelengths with a 10° angle of incidence. The ellipsometer shines a tunable light source on the diffraction grating 1000 and measures the scattered light at various angles. The minimum angular separation between the source and the detector of the ellipsometer is approximately 30°. As a result, the 10° angle of incidence was selected in order to measure the first diffraction order at approximately 10°. The peaks 1112 in plot 1100 reveal that most of the light with wavelengths in the range from 620-660 nm is strongly scattered into the first diffraction order at approximately 10°. Weaker peaks 1114 reveal that much less of the light was scattered into the second diffraction at approximately 22°. Note that at the design wavelength of 650 nm, the second diffraction order is effectively suppressed, while the first diffraction order has maximum intensity. The inset 1106 reveals the change in the reflection angle as a function of the incident wavelength.

As mentioned above with reference to FIG. 7, the flat region 720 of the phase profile contributes to diffraction in the zeroth diffraction order of the grating. Experimental and theoretical results of the scattering efficiency of the SWG 1002 with a flattened phase profile showing this effect in Table 1:

TABLE 1

| | Order | | | | |
|---|---|---|---|---|---|
| | −2 | −1 | 0 | 1 | 2 |
| Theory | 0.068 | 0.11 | 0.155 | 0.44 | 0.009 |
| Experiment | 0.014 | 0.014 | 0.14 | 0.39 | 0.019 |

The phase profile was in principle to be implemented using a combination of duty cycle and line spacing variation. The theoretical results are based on the SWG 1002. The complex reflection coefficient of the 170 nm thick SWG 120 was computed using RCWA. Table 1 shows both theoretical and experimental optical power distribution among diffraction orders of the high-contrast reflection diffraction grating. The theoretical results reveal that much of the optical power is expected to lie in the first diffraction order with a smaller portion diverted into the zeroth diffraction order, which is due to the line width and line spacing fabrication limitations. An ellipsometer does not allow for the measurement of the optical power in all diffraction orders, so the experimental results were obtained with a measurement using a laser at 640 nm with an incidence angle of approximately 5°. The experimental results are consistent with the theoretical results in that the largest amount of experimentally observed optical power was directed into the first diffraction order with a smaller portion of the optical power left in the zeroth diffraction order due to the flat portion 720 of the phase profile shown in FIG. 7. The other diffraction orders combined contain approximately 5% of the total optical power.

### Other Planar Reflective Device Embodiments

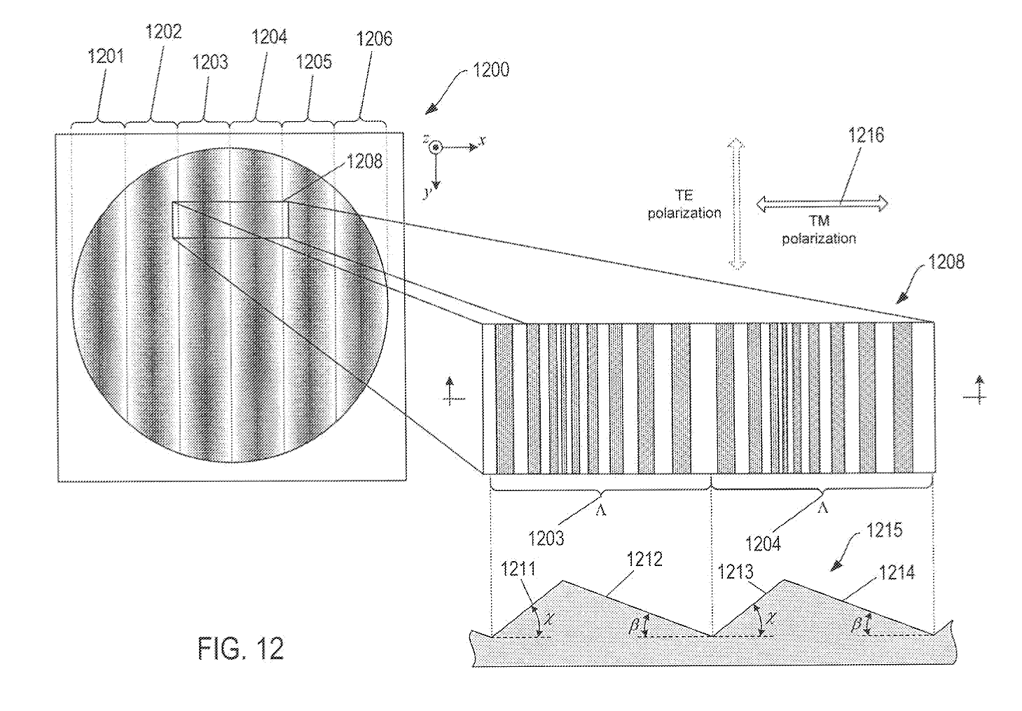

Planar reflective devices that operate in the same manner as blazed gratings are not intended to be limited to the design of the reflective device 300 described above. For example, the number of SWG regions configured to reflect light in the same manners the reflective surfaces of a blazed grating is not limited to six regions, but instead, can be composed of fewer than six regions or more than six regions. Also, the SWG can be designed to operate in the same manner as other types of blazed gratings for TM polarized light. FIG. 12 shows a top-plan view of a reflective device 1200 that includes six regions 1201-1206, each shaded to represent how the grating varies within each region in the x-direction. Each of the regions 1201-1206 operate like two adjacent reflective surfaces of a blazed grating for a selected wavelength of light but without surface blocking. In the example of FIG. 12, the SWG is a one-dimensional grating composed of approximately parallel lines separated by grooves as revealed by magnified top-plan view 1208 of regions 1203 and 1204. The magnified view 1208 shows lines that extend in the y-direction and are spaced in the x-direction. The lines comprising the SWG 302 have approximately the same thickness t throughout. As shown in the example of FIG. 12, the line widths and line spacings of the lines comprising each region are selected so that the each region operates like two adjacent reflective surfaces with blaze angles β and χ. For example, FIG. 12 shows four reflective surfaces 1211-1214 of a blazed grating 1215 with blaze angles β and χ. The regions 1203 and 1304 reflect light in the same manner as the reflective surfaces 1211-1214 but with TM polarization 1216.

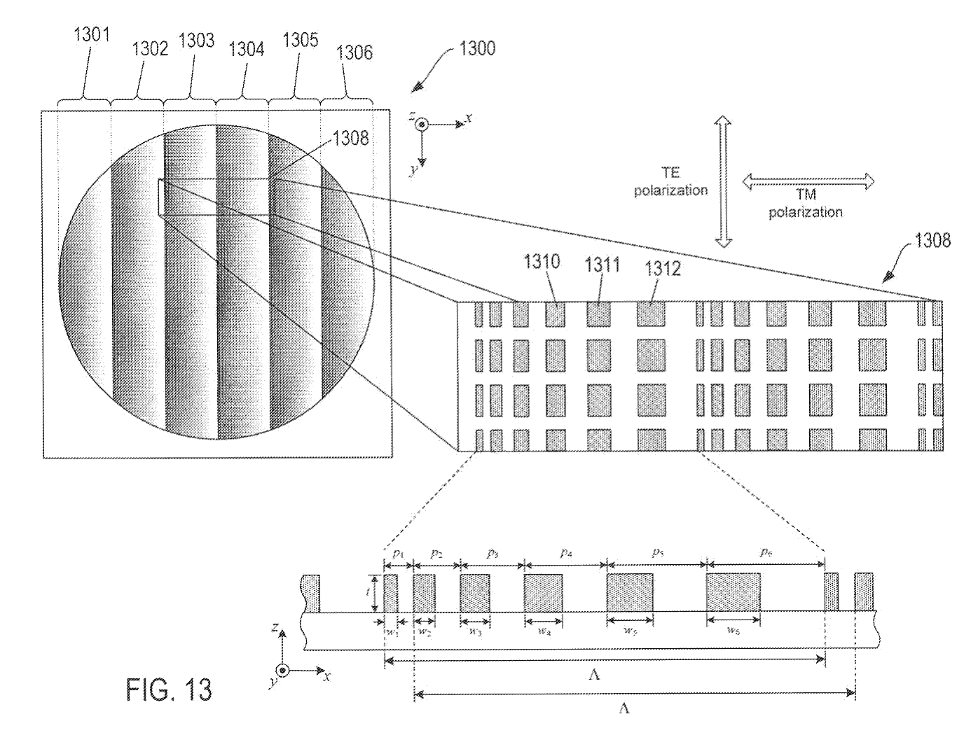

The SWG of a reflective device can also be a high-contrast, two-dimensional grating that operates like a polarization insensitive blazed grating for a selected wavelength. FIG. 13 shows a top-plan view of a polarization insensitive planar reflective device 1300 configured to operate in the same manner as the reflective device 300. The GMR 1300 includes six regions 1301-1306 that are each shaded to represent how the grating varies within each region in the x-direction. Each of the regions 1301-1306 operates like a reflective surface of a blazed grating for a selected wavelength of light but without surface blocking. Magnified top-plan view 1308 reveals that the SWG is composed of posts, such as posts 1310-1312, rather than lines, separated by grooves in both the x- and y-directions. In the example of FIG. 13, the posts have rectangular xy-plane cross-sections with the duty cycle varied in the x-direction and constant in the y-direction. Alternatively, the posts can be square, circular, elliptical or any other xy-plane cross-sectional shape or the two-dimensional SWG 118 can be composed of holes rather than posts. The holes can be square, rectangular, circular, elliptical or any other suitable size and shape for reflecting light a particular wavelength. Also the duty cycle can be varied in the x- and y-directions. The light reflected from the SWG is TM and TE polarized, as indicated by directional arrows 1314 and 1316.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. A reflective device including;
a substrate with a planar surface; and
a planar, high-contrast, sub-wavelength grating disposed on the surface, wherein the grating is divided into a number of regions that each reflect incident light of a particular wavelength and with a particular angle of incidence into a single diffraction order and associated diffraction angle.

2. The device of claim 1, wherein the planar grating has a substantially uniform thickness.

3. The device of claim 1, wherein the grating is a one-dimensional grating composed of substantially parallel lines that extend above the surface and are separated by grooves.

4. The device of claim 3, wherein within for each region, the line spacing and line widths are selected to reflect the light with the diffraction angle.

5. The device of claim 3, wherein the lines have a thickness that ensures the light reflected is substantially TM polarized.

6. The device of claim 1, wherein the grating is a two-dimensional grating composed of posts.

7. The device of claim 7, wherein within for each region, the spacing between posts and cross-sectional dimensions of the post is selected to reflect the light with the diffraction angle.

8. The device of claim 7, wherein the two-dimensional grating is polarization insensitive.

9. The device of claim 7, wherein the grating has a higher refractive index than the substrate.

10. A method of diffracting light, the method comprising:
directing light with an angle of incidence onto a planar reflective device, wherein the planar reflective device includes a substrate with a planar surface and a planar, high-contrast, sub-wavelength grating disposed on the surface and divided into a number of regions; and
reflecting the incident light from each region into a single diffraction order and associated diffraction angle.

11. The method of claim 10 wherein reflecting the incident light further includes reflecting the light with TM polarization.

12. The method of claim 10 wherein incident light is composed of a number of different wavelengths.

13. The method of claim 10, wherein the planar grating has a substantially uniform thickness.

14. The method of claim 10, wherein the grating is a one-dimensional grating composed of substantially parallel lines that extend above the surface and are separated by grooves.

15. The method of claim 14, wherein within for each region, the line spacing and line widths are selected to reflect the light with the diffraction angle.

16. The method of claim 14, wherein the lines have a thickness that ensures the light reflected is substantially TM polarized.

17. The method of claim 10, wherein the grating is a two-dimensional grating composed of posts.

18. The method of claim 17, wherein within for each region, the spacing between posts and cross-sectional dimensions of the post is selected to reflect the light with the diffraction angle.

19. The method of claim 17, wherein the two-dimensional grating is polarization insensitive.

20. The device of claim 10, wherein the grating has a higher refractive index than the substrate.
